(19) United States
(12) Patent Application Publication
(10) Pub. No.: US 2025/0158259 A1
(43) Pub. Date: May 15, 2025

(54) SYSTEMS AND METHODS FOR SUPPRESSION AND SECUREMENT OF BATTERY MODULES

(71) Applicant: Tyco Fire Products LP, Cranston, RI (US)

(72) Inventors: Sean S. Troutt, Stephenson, MI (US); Blake Bomann, Greenville, WI (US); Ben Markovitz, Howard, WI (US); David Strobel, Marinette, WI (US)

(73) Assignee: Tyco Fire Products LP, Cranston, RI (US)

(21) Appl. No.: 18/839,375

(22) PCT Filed: Mar. 23, 2023
(86) PCT No.: PCT/IB2023/052888

§ 371 Date: Aug. 16, 2024

Related U.S. Application Data
(60) Provisional application No. 63/323,626, filed on Mar. 25, 2022.

(51) Int. Cl. H01M 50/682; A62C 3/16; B60L 50/64; H01M 50/204; H01M 50/249

(52) U.S. Cl. CPC H01M 50/682; A62C 3/16; B60L 50/64; H01M 50/204; H01M 50/249; H01M 2220/20

(57) ABSTRACT

A container system includes a container, and a canister. The container defines an inner volume. Multiple modules are positioned within the inner volume. The modules include multiple battery cells. The canister is configured to store liquid CO2. The canister is removably fluidly coupled with the inner volume of the container. The canister is configured to discharge the liquid CO2 into the inner volume to suppress and freeze the battery cells prior to physical opening of the container.

### CROSS-REFERENCE TO RELATED PATENT APPLICATION

This application claims the benefit of and priority to U.S. Provisional Application No. 63/323,626, filed Mar. 25, 2022, the entire disclosure of which is incorporated by reference herein.

### BACKGROUND

The present disclosure relates generally to fire suppression systems. More specifically, the present disclosure relates to fire suppression systems for batteries. Modern battery technologies, such as lithium-ion batteries, are desirable for use in many energy storage applications due to their high energy density. However, the materials used in such batteries can be quite flammable and can produce flammable gases (e.g., when overheating). Once the batteries ignite, the resultant fires can be difficult to suppress due to their high temperatures, and the fires can travel quickly between adjacent battery cells. The cells of the batteries are often contained within a sealed housing, making it difficult for an external source of fire suppressant to reach the cells.

### SUMMARY

One embodiment of the present disclosure is a container system. The container system includes a container, and a canister. The container defines an inner volume. Multiple modules are positioned within the inner volume. The modules include multiple battery cells. The canister is configured to store liquid CO2. The canister is removably fluidly coupled with the inner volume of the container. The canister is configured to discharge the liquid CO2 into the inner volume to suppress and freeze the battery cells prior to physical opening of the container.

In some embodiments, the liquid CO2 freezes to form a rigid medium on the battery cells such that the battery cells can be removed from the container and handled while encapsulated by the rigid medium. The canister may activated to discharge the liquid CO2 into the inner volume to freeze the battery cells prior to opening the container in response to a user input.

In some embodiments, a first subset of the modules are positioned within a first subpack and a second subset of the modules are positioned within a second subpack. The first subpack and the second subpack are removable from the container.

In some embodiments, the canister is fluidly coupled with an interior of each of the modules of the first subpack and the second subpack such that the liquid CO2 is discharged into the modules. The container may include coupling port that is configured to fluidly couple with the canister. The coupling port fluidly couples the canister with inner volumes of each of the modules through tubular members. The liquid CO2 is configured to freeze to provide sublimation to the plurality of battery cells to mitigate thermal runaway of the plurality of battery cells.

Another embodiment of the present disclosure is a vehicle including a pack, and a canister. The pack defines an inner volume. Modules are positioned within the inner volume. The modules includes battery cells. The canister is configured to store liquid CO2. The canister is removably fluidly coupled with the inner volume of the pack. The canister is configured to discharge the liquid CO2 into the inner volume to suppress and freeze the battery cells immediately prior to physical opening of the pack.

In some embodiments, the liquid CO2 freezes to form a rigid medium on the battery cells such that the battery cells can be removed from the pack and handled while encapsulated by the rigid medium. The canister may be activated to discharge the liquid CO2 into the inner volume to freeze the battery cells prior to opening the pack in response to a user input.

In some embodiments, a first subset of the plurality of modules are positioned within a first subpack and a second subset of the modules are positioned within a second subpack. The first subpack and the second subpack are removable from the pack.

In some embodiments, the canister is fluidly coupled with an interior of each of the modules of the first subpack and the second subpack such that the liquid CO2 is discharged into the modules. The pack can include a coupling port that is configured to fluidly couple with the canister. The coupling port fluidly couples the canister with inner volumes of each of the modules through tubular members. The liquid CO2 is configured to freeze to provide sublimation to the battery cells to mitigate thermal runaway of the plurality of battery cells.

Another embodiment of the present disclosure is a method for suppressing battery cells and securing the battery cells. The method includes providing a container including the battery cells. The method also includes discharging a liquid CO2 agent into the container to suppress any fire at the battery cells, and freeze the plurality of battery cells. Freezing the battery cells secures the plurality of battery cells for physical removal from the container.

In some embodiments, the method further includes decoupling the liquid CO2 agent from the container. The method may also include opening the container to access the battery cells.

In some embodiments, the liquid CO2 agent freezes to form a rigid medium on the battery cells such that the battery cells can be removed from the container and handled while encapsulated by the rigid medium.

In some embodiments, the battery cells are positioned within modules. The liquid CO2 agent can be discharged into or onto the plurality of modules.

The liquid CO2 agent can be configured to freeze to provide sublimation to the battery cells to mitigate thermal runaway of the battery cells. Discharging the liquid CO2 agent into the container to freeze the battery cells can be performed prior to opening the container in response to a user input.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a schematic diagram of a battery system, according to an exemplary embodiment.

FIG. 2 is a block diagram of a control system for the battery system of FIG. 1, according to an exemplary embodiment.

FIG. 3 is a left side view of a vehicle utilizing the battery system of FIG. 1, according to an exemplary embodiment.

FIG. 4 is a perspective view of a containerized energy storage system including the battery system of FIG. 1, according to an exemplary embodiment.

FIG. 5 is diagram of a removable suppression and securement system for providing liquid carbon dioxide to the interior of a battery pack, according to an exemplary embodiment.

FIGS. 6-7 are diagrams of a removable suppression and securement system for providing liquid carbon dioxide to the interior of battery packs of a container, according to an exemplary embodiment.

FIG. 8 is a flow diagram of a process for suppressing and securing battery cells for removal, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods for using liquid carbon dioxide (CO2) to cool and secure batteries are shown. The systems and methods can be performed to encapsulate battery cells, modules, packs, or systems by freezing the battery cells, modules, packs, or systems in solidified gaseous agent(s) that is produced by application and subsequent rapid freezing of liquid gaseous agent such as liquid CO2. The application of the liquid CO2 can be performed after extinguishment or suppression to stabilize batteries for removal and transportation. Solidified gaseous agents may provide cooling to extend suppression time through sublimation (e.g., by continuing to vaporize to maintain reduced temperatures for a longer period of time such as several hours or up to a day). The systems and methods can also facilitate encapsulating the cells in a rigid medium making them stable for handling and transportation. Agent (e.g., liquid CO2) can be reapplied as need to maintain hazard stabilization and securement. The systems and methods described herein may be insensitive to environment or battery system design. The systems and methods described herein are also compatible with a wide variety with fire suppression technologies. In some embodiments, the agent is also minimally electrically conductive, thereby reducing electric shock potential.

Damaged batteries are often in a fragile state after a thermal runaway event or fire which may cause unpredictable re-initiation or thermal event. Agent sublimation can eliminate the need to dispose of battery stabilizing agent. The systems and methods described herein may be adaptable with current and future fire suppression technologies. The agents used to secure and/or suppress the batteries can include any liquefied gas such as helium, argon, nitrogen, carbon dioxide, a combination of gases, or a combination of gases and liquid agents such as water.

### System Overview

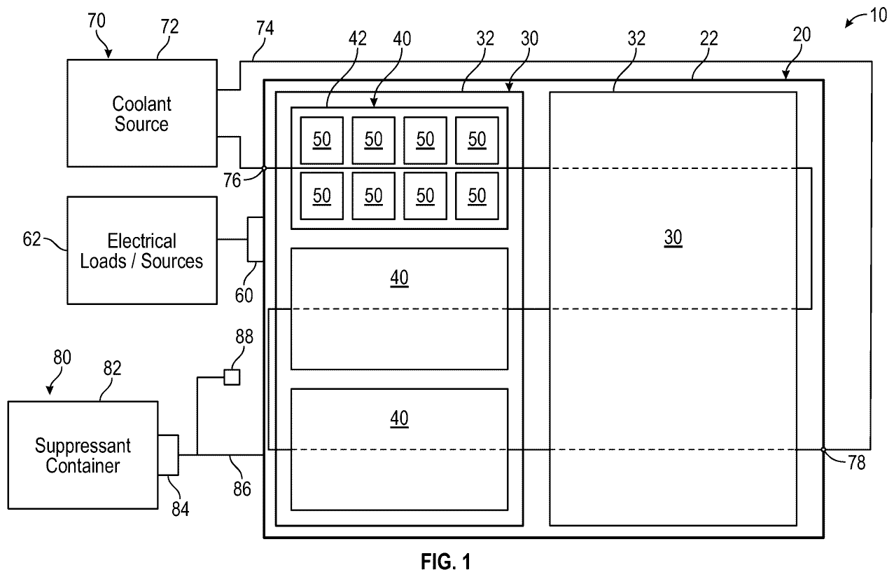

Referring to FIG. 1, a power system or battery system, shown as system 10, includes an energy storage device, energy storage assembly, battery assembly, power source, or electrical energy source, shown as battery pack 20, according to an exemplary embodiment. The battery pack 20 is configured to store energy (e.g., chemically) and later discharge the stored energy as electrical energy to power one or more electrical loads (e.g., electric motors, resistive elements, lights, speakers, etc.). In some embodiments, the battery pack 20 is rechargeable using electrical energy (e.g., from an electrical grid, from a fuel cell, from a solar panel, from an electrical motor being driven as a generator, etc.).

The battery pack 20 includes a shell or housing, shown as pack housing 22, that defines a volume containing components of the battery pack 20 (e.g., the subpacks 30). The pack housing 22 may seal the components of the battery pack 20 from the surrounding environment (e.g., limiting or preventing ingress of water or dust). The pack housing 22 may define one or more ports to facilitate transfer of electrical energy, coolant, fire suppressant, or other material into or out of the battery pack 20.

The battery pack 20 includes a series of battery portions or sections, shown as subpacks 30. By way of example, the battery pack 20 may include four subpacks 30. In other embodiments, the battery pack 20 includes more or fewer subpacks 30. Each subpack 30 is configured to store a portion of the stored energy of the battery pack 20. Each subpack 30 includes a housing 32 containing components of the subpack 30 (e.g., the battery modules 40).

Each subpack 30 includes a series of battery portions or sections, shown as battery modules 40. By way of example, each subpack 30 may include eight battery modules 40. In other embodiments, each subpack 30 includes more or fewer battery modules 40. Each battery module 40 is configured to store a portion of the stored energy of the corresponding subpack 30. Each battery module 40 includes a housing 42 containing components of the battery module 40 (e.g., the battery cells 50).

Each battery module 40 includes a series of battery portions or sections, shown as battery cells 50. By way of example, each battery module 40 may include hundreds of battery cells 50. In other embodiments, each battery module 40 includes more or fewer battery cells 50. Each battery cell 50 is configured to store a portion of the energy stored by the corresponding battery module 40.

In some embodiments, the battery cells 50 are lithium-ion (i.e., Li-ion) battery cells. Each battery cell 50 may be configured to receive electrical energy, store the received energy chemically, and release the stored electrical energy. As shown in FIG. 1, the battery cells 50 are arranged in rows adjacent one another within the battery module 40, reducing empty space within the battery module 40 and reducing the overall size of the battery pack 20. The battery cells 50 may be cylindrical cells, prismatic cells, pouch cells, or another form factor of battery cells.

The battery cells 50 may be electrically coupled to one another within the battery pack 20. By way of example, in one arrangement (a) the battery cells 50 within each battery module 40 are electrically coupled to one another, (b) the battery modules 40 within each subpack 30 are electrically coupled to one another, and (c) the subpacks 30 are electrically coupled to one another. The collective arrangement of battery cells 50, battery modules 40, and subpacks 30 is electrically coupled to a connector or port, shown as electrical port 60. The electrical port 60 electrically couples the battery cells 50 to one or more electrical sources and/or loads, shown as electrical loads/sources 62. The battery cells 50 may be discharged through the electrical port 60 to power the electrical loads/sources 62. The battery cells 50 may receive electrical energy through the electrical port 60 to charge the battery cells 50.

The battery cells 50, the battery modules 40, and the subpacks 30 may be arranged in series/parallel to control the output voltage of the battery pack 20 at the electrical port 60 and the capacity of the battery pack 20 at that output voltage. Battery cells 50 may be arranged in series with one another to increase an output voltage of the battery pack 20. Battery cells 50 may be arranged in parallel with one another to increase the capacity (e.g., measured in amp-hours) of the battery pack 20. By way of example, the battery modules 40 within each subpack 30 may be connected to one another in series, forming a string. The subpacks 30 may be connected to one another in parallel, such that the strings are connected in parallel.

In other embodiments, the battery pack 20 is otherwise arranged. By way of example, the battery pack 20 may include more or fewer battery cells 50, battery modules 40, and/or subpacks 30. By way of another example, the battery cells 50, battery modules 40, and/or subpacks 30 may be arranged in rows, columns, helical patterns, or otherwise positioned within the pack housing 22. In some embodiments, the subpacks 30 are omitted, and the battery modules 40 are positioned directly within the battery pack 20.

In some embodiments, the system 10 includes a cooling subsystem, shown as cooling system 70. The cooling system 70 includes a coolant source 72 that is configured to supply a flow of coolant to one or more conduits, shown as cooling channels 74. The coolant source 72 may include pumps, reservoirs, valves, and/or other components that facilitate handling the coolant. The coolant source 72 may also include one or more radiators or heat exchangers that facilitate discharging thermal energy from the coolant (e.g., to the surrounding atmosphere).

The cooling channels 74 pass into the pack housing 22 at an inlet 76 and exit the pack housing 22 at an outlet 78. The cooling channels 74 pass through the housings 32 of the subpacks 30 and the housings 42 of the battery modules 40 and pass adjacent (e.g., in contact with) the battery cells 50. In some embodiments, at least a portion of the cooling channels 74 is contained within and/or pass along the walls of the pack housing 22, the housings 32, and/or housings 42. The cooling channels 74 facilitate conduction between the coolant and the battery cells 50, such that thermal energy generated by the battery cells 50 (e.g., when charging or discharging electrical energy) is transferred to the coolant. The flow of coolant then transfers the thermal energy back to the coolant source 72 to be discharged. Accordingly, the cooling system 70 facilitates maintaining a consistent, low operating temperature of the battery pack 20.

Referring to FIG. 1, the system 10 further includes a fire suppression system, fire prevention system, or fire mitigation system, shown as suppression system 80. The suppression system 80 is configured to address fires within the battery pack 20 by supplying a fire suppressant. The suppressant may suppress active fires (e.g., preventing the fire from accessing oxygen). The suppressant may also cool the battery cells 50, preventing later ignition or reignition of the battery cells. The suppression system 80 may advantageously prevent, address, or otherwise mitigate thermal runaway of the battery cells 50.

The suppression system 80 includes a container of suppressant (e.g., a tank, a vessel, a cartridge, a reservoir, etc.) or fire suppressant source, shown as suppressant container 82. The suppressant may be held at an elevated pressure to facilitate dispensing the suppressant. The suppressant may include a gas (e.g., an inert gas, nitrogen, etc.), a liquid suppressant (e.g., water), a gel suppressant, a dry chemical suppressant, another type of suppressant, or combinations thereof.

The suppression system 80 further includes an actuator, shown as activator 84, that is configured to initiate a transfer (e.g., a flow) of fire suppressant from the suppressant container 82 to the battery pack 20. By way of example, the activator 84 may include a valve or seal puncture actuator that selectively permits suppressant to flow out of the suppressant container 82. By way of another example, the activator 84 may include a pump that is configured to impel the flow of suppressant.

The suppression system 80 further includes one or more conduits (e.g., pipes, hoses, tubes, etc.), shown as distribution network 86, that is configured to transfer suppressant from the suppressant container 82 to the battery pack 20. The distribution network 86 may transfer the suppressant to the interior of the battery pack 20 (e.g., inside the pack housing 22, inside the housing 32, inside the housing 42, etc.). Additionally or alternatively, the distribution network 86 may transfer the suppressant to the exterior of the battery pack 20. By way of example, the distribution network 86 may provide the suppressant to an outlet, shown as nozzle 88, that is positioned to direct suppressant to the exterior of the pack housing 22.

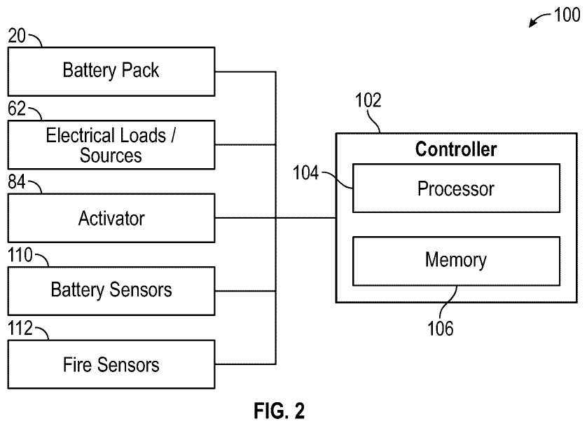

Referring to FIG. 2, a control system 100 of the system 10 is shown according to an exemplary embodiment. The control system 100 includes a processing circuit, shown as controller 102, including a processor 104 and a memory 106. The processor 104 may execute one or more instructions stored within the memory 106 to perform any of the functions described herein.

As shown, the controller 102 is operatively coupled to the battery pack 20, the electrical loads/sources 62, and the activator 84. The controller 102 may be configured to control operation of the battery pack 20 (e.g., as a battery management system), the electrical loads/sources 62, the suppression system 80, or any other component of the system 10. By way of example, the controller 102 may control charging and/or discharging of the battery pack 20. By way of another example, the controller 102 may control activation of the suppression system 80 to address one or more fires.

The control system 100 further includes one or more sensors, shown as battery sensors 110, operatively coupled to the controller 102. The battery sensors 110 may be configured to provide sensor data measuring one or more parameters related to the performance of the battery pack 20. By way of example, the battery sensors 110 may measure a current, voltage, and/or charge level within the battery pack 20. The battery sensors 110 may measure performance at the battery cell 50 level, the battery module 40 level, the subpack 30 level, and/or the battery pack 20 level. In some embodiments, the controller 102 is configured to use information from the battery sensors 110 to detect or predict a thermal event (e.g., a fire) associated with the battery pack 20. By way of example, the controller 102 may identify a change in measured current, voltage, or charge level that is indicative of a fire.

The control system 100 further includes one or more sensors, shown as thermal event sensors 112, configured to detect or predict a thermal event (e.g., a fire) associated with the battery pack 20. By way of example, the thermal event sensors 112 may include temperature sensors configured to detect an increase in temperature (e.g., of one of the battery cells 50) associated with a fire or a prediction of a fire. By way of another example, the thermal event sensors 112 may include an aspirating smoke detector that is configured to identify the presence of smoke or a gas that is produced (e.g., offgassed) when the battery cells 50 are above the standard operating temperature range. By way of another example, the thermal event sensors 112 may include an optical sensor that detects light produced by a fire.

In response to detection or prediction of a fire, the controller 102 may activate the suppression system 80 to address (e.g., prevent or suppress) the fire. By way of example, the controller 102 may actuate the activator 84 to direct suppressant to the battery pack 20. This suppressant may enter and/or surround the battery pack 20, addressing the fire.

Although a single controller 102 is shown in FIG. 2, it should be understood that the functionality of the controller 102 may be distributed across two or more separate controllers in communication with one another. By way of example, a first controller (e.g., a battery controller) may be dedicated for the battery management (e.g., controlling power usage from the battery cells 50 and charging of the battery cells 50). A second controller (e.g., a fire system controller) may be dedicated for management of the fire suppression system 80 (e.g., control over the activator 84 and the thermal event sensors 112). The two controllers would have the ability to communicate with each other such that when the fire system controller detects a fire, the fire system controller provides a signal to the battery controller. This signal commands the battery controller to disconnect or shut down usage of the affected batteries (e.g., battery packs 20, subpacks 30, battery modules 40, and/or battery cells 50) prior to discharging the fire suppression system 80.

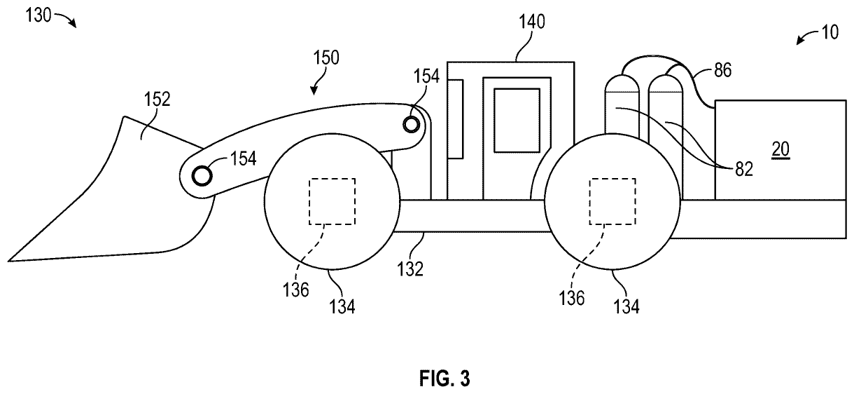

Referring to FIG. 3, a vehicle 130 is equipped with the battery system 10, according to an exemplary embodiment. As shown, the vehicle 130 is configured as a mining vehicle. Specifically, the vehicle 130 is configured as a front end loader. In other embodiments, the vehicle 130 is configured as another type of vehicle, such as a forestry vehicle, a passenger vehicle (e.g., a bus), a boat, or yet another type of vehicle.

The vehicle 130 includes a frame, shown as chassis 132, that is coupled to and supports a battery pack 20 and a pair of suppressant containers 82. The vehicle 130 includes a series of tractive elements (e.g., wheel and tire assemblies), shown as tractive elements 134, that are rotatably coupled to the chassis 132. The tractive elements 134 engage a support surface (e.g., the ground) to support the vehicle 130. The tractive elements 134 are coupled to a series of electric actuators or prime movers, shown as drive motors 136. The drive motors 136 are configured to drive the tractive elements 134 to propel the vehicle 130. In some embodiments, the drive motors 136 are electrically coupled to the battery pack 20. The drive motors 136 may consume electrical energy from the battery pack 20 (e.g., when propelling the vehicle 130) and/or provide electrical energy to charge the battery pack 20 (e.g., when performing regenerative braking).

The vehicle 130 further includes an operator compartment or cabin, shown as cab 140, that is coupled to the chassis 132. The cab 140 may be configured to contain one or more operators of the vehicle 130. The cab 140 may include one or more user interface elements (e.g., steering wheels, pedals, shifters, switches, knobs, dials, screens, indicators, etc.) that facilitate operation of the vehicle 130 by an operator.

The vehicle 130 further includes an implement assembly 150 coupled to the chassis 132. As shown, the implement assembly 150 includes an implement, shown as bucket 152. The implement assembly 150 further includes one or more actuators (e.g., electric motors, electric linear actuators, etc.), shown as implement actuators 154, that are configured to cause movement of the bucket 152 relative to the chassis 132. The implement actuators 154 may be electrically coupled to the battery pack 20. The implement actuators 154 may consume electrical energy from the battery pack 20 (e.g., when moving the bucket 152) and/or provide electrical energy to charge the battery pack 20 (e.g., when slowing the movement of the bucket 152).

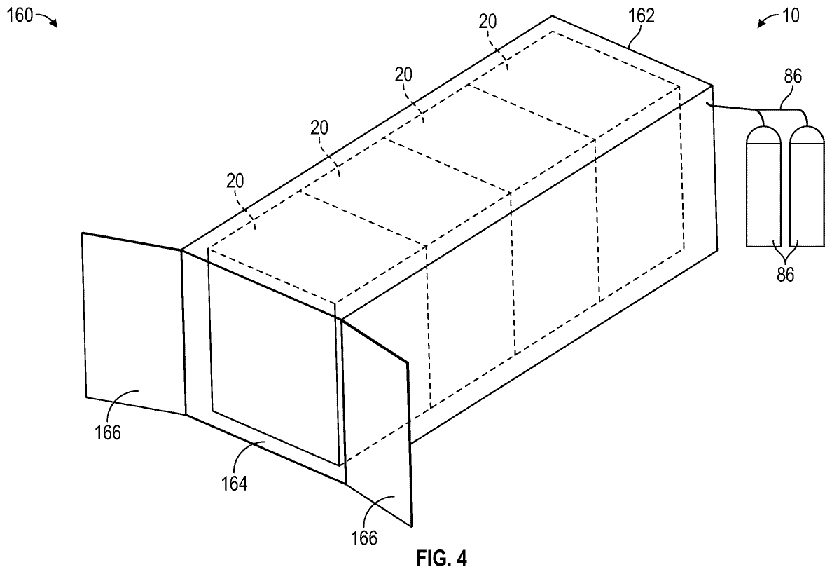

Referring to FIG. 4, a containerized energy storage system, shown as container system 160, is equipped with the battery system 10, according to an exemplary embodiment. In some embodiments, the container system 160 is configured to store energy to power one or more external electrical loads. The container system 160 may be portable (e.g., using a crane, using a container ship, using a semi truck, etc.).

As shown, the container system 160 includes a container, shown as shipping container 162, defining an internal volume 164. The internal volume 164 is selectively accessible from outside of the shipping container 162 through one or more doors 166. The internal volume 164 contains a series of battery packs 20 coupled to the shipping container 162. The battery packs 20 may be electrically coupled to one another, providing a large energy storage capacity.

### CO2 for Securement

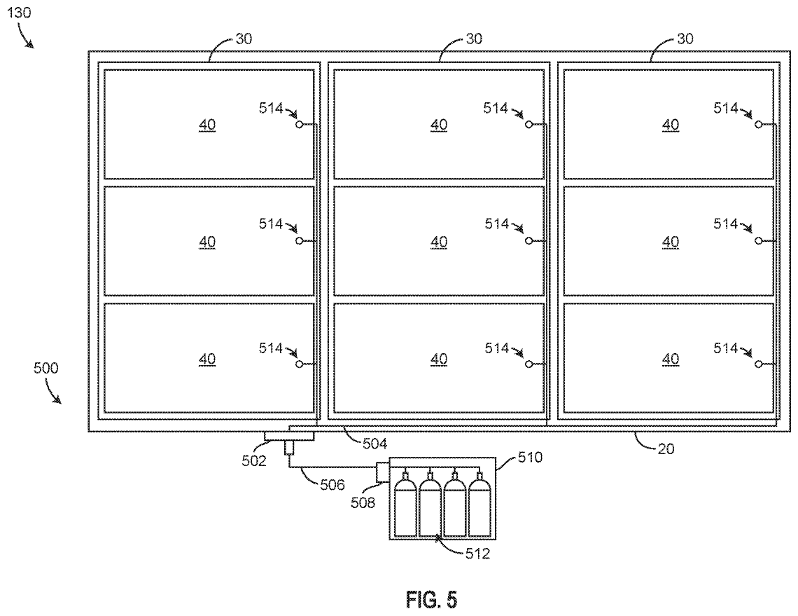

Referring to FIGS. 5-8, systems and methods for suppressing and/or securing batteries (e.g., the battery cells 50, the modules 40, etc.) of the vehicle 130, or the container system 160 are shown. The systems and methods can be performed to introduce liquid CO2 or another agent to cause freezing of the modules 40 so that any conditions that can cause thermal runaway or combustion are suppressed, and to secure the modules 40 for removal from the packs 20, or from the shipping container 162. Any of the systems and methods described herein with reference to FIGS. 5-8 can be performed after fire suppression is provided (e.g., after operation of the suppression system 80), before physically opening the pack 20 or the shipping container 162, or even when fire suppression has not been previously performed, but the pack 20 or the shipping container 162 are about to be physically opened.

Referring particularly to FIG. 5, the vehicle 130 is shown equipped with a suppression and securement system 500. The suppression and securement system 500 is configured to provide liquid CO2 (or another agent) to an interior of the pack 20 so that fire suppression is provided to the various battery cells 50, modules 40, subpacks 30, etc., and so that the battery cells 50, the modules 40, the subpacks 30, etc., are frozen and thereby secured for removal from the pack 20.

The suppression and securement system 500 may be a component of the vehicle 130, or the vehicle 130 and therefore the pack 20 may be components of the suppression and securement system 500. The suppression and securement system 500 includes an agent unit 510 that includes one or more canisters, cartridges, tanks, reservoirs, etc., shown as agent canisters 512. The agent unit 510 may be external to the pack 20. In some embodiments, the agent unit 510 is a portable unit, and may be provided as a handheld portable unit, a wheeled unit, a fire extinguisher, a contained unit, etc. In some embodiments, the agent canisters 512 are configured to store CO2 in a liquid phase for introduction to the pack 20 to suppress and secure (e.g., freeze) the modules 40. Any of the embodiments of the suppression and securement system 500 as described herein may be configured to perform any of the functionality of the systems and methods described in greater detail in WO2022/009120, filed Apr. 7, 2021, the entire disclosure of which is incorporated by reference herein.

The agent unit 510 also includes an activator 508 that can be the same as or similar to any of the activators 84 as described in greater detail above. The activator 508 can be configured to selectively fluidly couple inner volumes of the agent canisters 512 with a distribution system 504 of the pack 20 (e.g., a piping system, a hose system, etc.) so that the liquid CO2 is discharged into inner volumes of the modules 40. The activator 508 can be manually operated by a user of the agent unit 510 so that the agent canisters 512 operate to discharge the liquid CO2.

The agent canisters 512 are fluidly coupled with inner volumes of the modules 40 (or inner volumes of the subpacks 30, or inner volume of the pack 20) through distribution system 504, a coupling port 502 in a side of the pack 20, a conduit 506 (e.g., a hose, a pipe, a tubular member, etc.), and the activator 508. When the activator 508 is activated, a fluid flow path is defined between the inner volumes of the agent containers 512 through outlets of the agent containers 512, the activator 508 (e.g., a valve of the activator 508), the conduit 506, the coupling port 502, and the distribution system 504. The distribution system 504 can include nozzles 514 that are positioned within each of the modules 40 and are fluidly coupled along the distribution system 504. The nozzles 514 may be outlets of the distribution system 504 so that the liquid CO2 exits the distribution system 504 into the inner volumes of the modules 40 through the nozzles 514.

Once the liquid CO2 enters the modules 40 through the distribution system 504 and the nozzles 514, a first portion of the liquid CO2 may evaporate into a gas. Due to the first portion evaporating, a second portion of the liquid CO2 cools rapidly until it solidifies, and thereby cools and freezes the battery cells 50, the modules 40, and the subpacks 30. The rapid decrease in temperature of the second portion of the CO2 (e.g., the second portion of the CO2 that is introduced into each module 40) both suppresses any fires, thermal events, thermal runaway, off-gases, etc., that is within the modules 40, and also secures the modules 40 for removal from the subpacks 30 by providing a solid rigid structure (e.g., a block of dry ice) which encapsulates all the internal components of the module or sub-packs, or more generally, secures the subpacks 30 for removal from the pack 20.

The agent unit 510 may be removably fluidly coupled with the distribution system 504 of the pack 20 through the coupling port 502. For example, when a user arrives to the pack 20 (e.g., after fire suppression has been performed at the pack 20, prior to removal of components of the pack 20, prior to physically opening the pack 20, etc.), the user may fluidly couple the conduit 506 with the distribution system 504 by attaching the end of the conduit 506 on the coupling port 502. The user may then operate the activator 508 (e.g., press a switch, pull a plug, twist a knob, turn a screw, release a valve, etc.) so that the liquid CO2 is provided into the pack 20 from the agent containers 512.

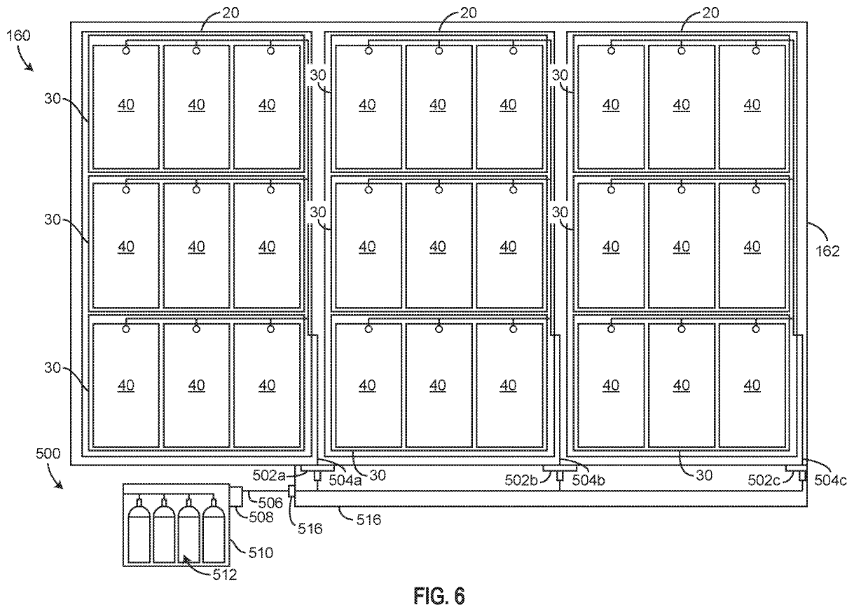

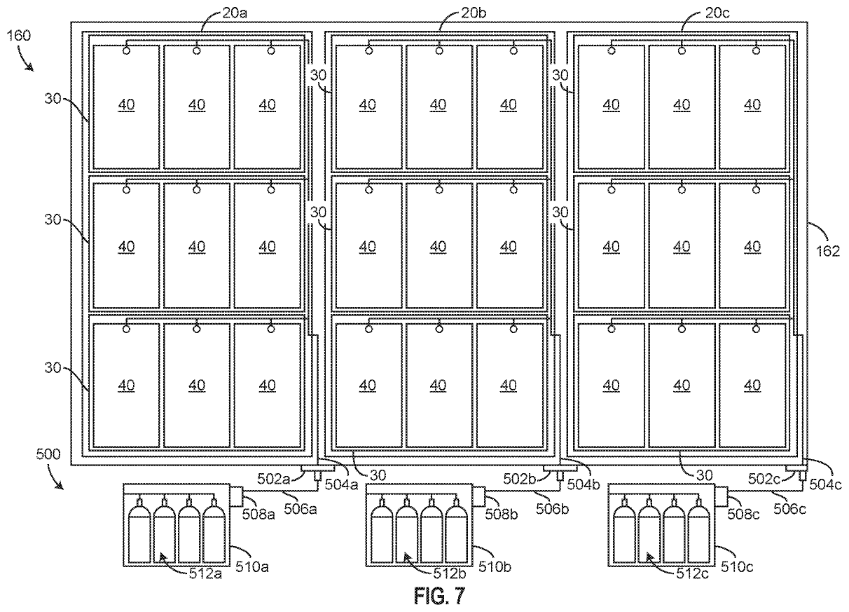

Referring to FIGS. 6 and 7, the suppression and securement system 500 can also be configured for use with the shipping container 162 of the container system 160. The suppression and securement system 500 can be a component of the container system 160, or the container system 160 may be a component of the suppression and securement system 500.

Referring particularly to FIG. 6, the suppression and securement system 500 can include a single agent unit 510 that is configured to provide liquid CO2 to inner volumes of each of the modules 40 of the packs 20 within the shipping container 162. The shipping container 162 can include a manifold 516 that includes piping to fluidly couple each of multiple coupling ports 502a, 502b, and 502c, with a single coupling port 516. The manifold 516 can be positioned externally from the shipping container 162, or within the shipping container 162. In some embodiments, the manifold 516 is a conduit system (either internal to the shipping container 162, or external to the shipping container 162 such as along a side of the shipping container 162) that fluidly couples each of multiple distribution systems 504a, 504b, and 504c with the single coupling port 516. In this way, the single agent unit 510 can be fluidly coupled with each of the distribution systems 504a, 504b, and 504c, so that the single agent unit 510 can provide liquid CO2 to interiors of each of multiple packs 20. Each of the distribution system 504a, 504b, and 504c are configured to serve or direct liquid CO2 to a corresponding pack 20 of the shipping container 162. It should be understood that while the shipping container 162 is shown in FIGS. 6 and 7 to include three packs 20, with three distribution systems 504, and three couplers 502, the shipping container 162 can include any number of packs 20, corresponding distribution systems 504, and couplers 502. The single agent unit 510 can be fluidly coupled via the conduit 506 to the single coupling port 516 to distribute liquid CO2 into the packs 20 of the shipping container 162 (e.g., to provide suppression and securement or freezing for the modules 40 of each of the packs 20).

Referring particularly to FIG. 7, the shipping container 162 can include the multiple coupling ports 502a, 502b, and 502c, exposed to an exterior of the shipping container 162 so that one or more agent units 510 can be directly coupled with the coupling ports 502 via the conduit 506. For example, a first agent unit 510a may be directly coupled with a first coupling port 502a so that the first agent unit 510a can provide liquid CO2 into the modules 40 of a first pack 20a of the shipping container 162 via a first distribution system 504a that serves the first pack 20a. A second agent unit 510b may be directly coupled with a second coupling port 502b so that the second agent unit 510b can provide liquid CO2 into the modules 40 of a second pack 20b of the shipping container 162 via a second distribution system 504b that serves the second pack 20a. A third agent unit 510c may be directly coupled with a third coupling port 502c so that the third agent unit 510c can provide liquid CO2 into the modules 40 of a third pack 20c of the shipping container 162 via a third distribution system 504c that serves the third pack 20a. The first agent unit 510a, the second agent unit 510b, and the third agent unit 510c, can each be activated by operation of their corresponding activators 508a, 508b, and 508c (e.g., after fluidly coupling the agent units 510 with the coupling ports 502).

In some embodiments, a single agent unit 510 can sequentially be fluidly coupled with one of the coupling ports 502, operated to discharge an amount of liquid CO2 into the modules 40 of the corresponding pack 20, decoupled from the coupling port 502, and repeated at the remaining coupling ports 502. In this way, a single agent unit 510 can be used to provide liquid CO2 to the modules 40 of each of the packs 20.

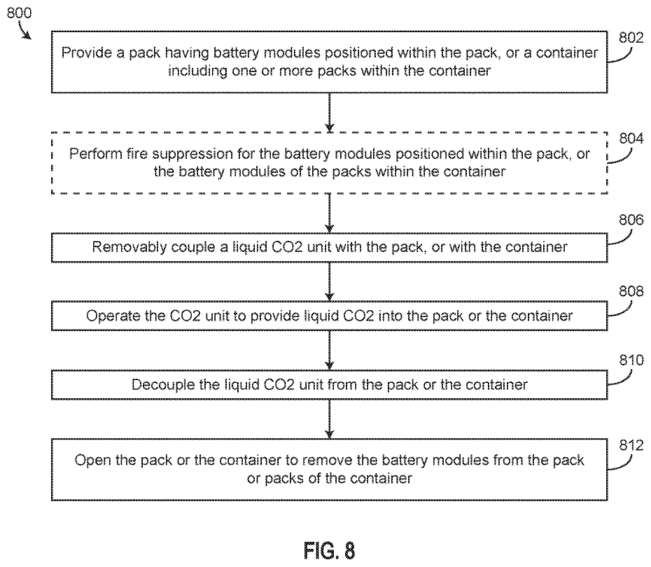

Referring to FIG. 8, a process 800 for suppressing and providing securement (e.g., freezing) to one or more modules of a pack or a container (e.g., the pack 20 of the vehicle 130, or the shipping container 162) includes steps 802-812 and can be performed in order to suppress and freeze the modules prior to physically opening the pack or container to remove the modules.

Process 800 includes providing a pack having battery modules positioned within the pack, or a container including one or more packs within the container (step 802), according to some embodiments. In some embodiments, the pack is the pack 20 of the vehicle 130. In some embodiments, the container is the shipping container 162.

Process 800 includes performing fire suppression for the battery modules positioned within the pack or the battery modules of the packs within the container (step 804), according to some embodiments. In some embodiments, step 804 is optional. In some embodiments, step 804 is performed by activating the suppression system 80 so that the suppression system 80 introduces a suppressant into the pack or the packs of the container.

Process 800 includes removably coupling a liquid CO2 unit with the pack, or with the container (step 806), according to some embodiments. In some embodiments, step 806 is performed by an operator and includes coupling the agent unit 510 with a coupling port (e.g., the coupling port 502) via a conduit (e.g., the conduit 506). In some embodiments, the CO2 unit is a portable or wheeled unit. The CO2 unit can be coupled with a coupler or fitting of the pack or the container. In some embodiments, the coupler or fitting is a quick-connect or a compression fit fitting. Performing step 806 can result in defining a fluid flow path between a reservoir of liquid CO2 of the CO2 unit with inner volumes of the battery modules so that the CO2 unit can provide the liquid CO2 to the battery modules.

Process 800 includes operating CO2 unit to provide liquid CO2 into the pack of the container (step 808), according to some embodiments. In some embodiments, step 808 includes operating an activator (e.g., the activator 508 of the CO2 unit) so that the liquid CO2 flows along the path as defined in step 806. In some embodiments, step 808 is performed by manually operating the activator of the CO2 unit.

Process 800 includes decoupling the liquid CO2 unit from the pack or the container (step 810), and opening the pack or the container to remove the battery modules from the pack or packs of the container (step 812), according to some embodiments. In some embodiments, steps 810 and 812 are performed by the user immediately after step 808 is performed so that the battery modules can be removed.

In some embodiments, the process 800 may be performed for a battery module, subpack, pack, etc., that is already flooded with a liquid agent (e.g., a suppressant). In this case, the liquid CO2 may, instead of turning into dry ice and subliming at a temperature of −78.5 degrees Celsius, cool to a different temperature, depending on the properties of the liquid agent. The liquid CO2 may become a rigid solid or a liquid/solid mixture (e.g., a slush or slurry mixture), and may cool the battery cells 50 to a temperature such that the battery cells 50 are safe to handle and remove.

### Configuration of the Exemplary Embodiments

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system 10 as shown in the various exemplary embodiments is illustrative only. Additionally, any element disclosed in one embodiment may be incorporated or utilized with any other embodiment disclosed herein. For example, the arrangement of multiple battery packs 20 of the exemplary embodiment shown in at least FIG. 4 may be incorporated in the vehicle 130 of the exemplary embodiment shown in at least FIG. 3. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A container system comprising:
a container defining an inner volume, a plurality of modules positioned within the inner volume, the plurality of modules comprising a plurality of battery cells; and
a canister configured to store liquid CO2, the canister removably fluidly coupled with the inner volume of the container;
wherein the canister is configured to discharge the liquid CO2 into the inner volume to suppress and freeze the plurality of battery cells prior to physical opening of the container.

2. The container system of claim 1, wherein the liquid CO2 freezes to form a rigid medium on the plurality of battery cells such that the plurality of battery cells are removable from the container and handleable while encapsulated by the rigid medium.

3. The container system of claim 1, wherein the canister is activated to discharge the liquid CO2 into the inner volume to freeze the plurality of battery cells prior to opening of the container in response to a user input.

4. The container system of claim 1, wherein a first subset of the plurality of modules are positioned within a first subpack and a second subset of the plurality of modules are positioned within a second subpack, wherein the first subpack and the second subpack are removable from the container.

5. The container system of claim 4, wherein the canister is fluidly coupled with an interior of each of the plurality of modules of the first subpack and the second subpack such that the liquid CO2 is discharged into the plurality of modules.

6. The container system of claim 1, wherein the container comprises a coupling port configured to fluidly couple with the canister, the coupling port fluidly coupling the canister with inner volumes of each of the plurality of modules through a plurality of tubular members.

7. The container system of claim 1, wherein the liquid CO2 is configured to freeze to provide sublimation to the plurality of battery cells to mitigate thermal runaway of the plurality of battery cells.

8. A vehicle comprising:
a pack defining an inner volume, a plurality of modules positioned within the inner volume, the plurality of modules comprising a plurality of battery cells; and
a canister configured to store liquid CO2, the canister removably fluidly coupled with the inner volume of the pack;
wherein the canister is configured to discharge the liquid CO2 into the inner volume to suppress and freeze the plurality of battery cells immediately prior to physical opening of the pack.

9. The vehicle of claim 8, wherein the liquid CO2 freezes to form a rigid medium on the plurality of battery cells such that the plurality of battery cells are removable from the pack and handleable while encapsulated by the rigid medium.

10. The vehicle of claim 8, wherein the canister is activated to discharge the liquid CO2 into the inner volume to freeze the plurality of battery cells prior to opening the pack in response to a user input.

11. The vehicle of claim 8, wherein a first subset of the plurality of modules are positioned within a first subpack and a second subset of the plurality of modules are positioned within a second subpack, wherein the first subpack and the second subpack are removable from the pack.

12. The vehicle of claim 11, wherein the canister is fluidly coupled with an interior of each of the plurality of modules of the first subpack and the second subpack such that the liquid CO2 is discharged into the plurality of modules.

13. The vehicle of claim 8, wherein the pack comprises a coupling port configured to fluidly couple with the canister, the coupling port fluidly coupling the canister with inner volumes of each of the plurality of modules through a plurality of tubular members.

14. The vehicle of claim 8, wherein the liquid CO2 is configured to freeze to provide sublimation to the plurality of battery cells to mitigate thermal runaway of the plurality of battery cells.

15. A method for suppressing a plurality of battery cells and securing the plurality of battery cells, the method comprising:
providing a container comprising the plurality of battery cells; and
discharging a liquid CO2 agent into the container to suppress any fire at the plurality of battery cells, and freeze the plurality of battery cells, wherein freezing the plurality of battery cells secures the plurality of battery cells for physical removal from the container.

16. The method of claim 15, further comprising:
decoupling the liquid CO2 agent from the container; and
opening the container to access the plurality of battery cells.

17. The method of claim 15, wherein the liquid CO2 agent freezes to form a rigid medium on the plurality of battery cells such that the plurality of battery cells are removable from the container and handleable while encapsulated by the rigid medium.

18. The method of claim 15, wherein the plurality of battery cells are positioned within a plurality of modules, the liquid CO2 agent discharged into or onto the plurality of modules.

19. The method of claim 15, wherein the liquid CO2 agent is configured to freeze to provide sublimation to the plurality of battery cells to mitigate thermal runaway of the plurality of battery cells.

20. The method of claim 15, wherein discharging the liquid CO2 agent into the container to freeze the plurality of battery cells is performed prior to opening the container in response to a user input.
